(19) United States
(12) Patent Application Publication
(10) Pub. No.: US 2026/0356372 A1
(43) Pub. Date: Nov. 12, 2026

(54) METHOD FOR OPERATING A DRIVER ASSISTANCE SYSTEM FOR A VEHICLE, DRIVER ASSISTANCE SYSTEM AND MOTOR VEHICLE HAVING A DRIVER ASSISTANCE SYSTEM

(71) Applicant: Valeo Schalter und Sensoren GmbH, Bietigheim-Bissingen (DE)

(72) Inventor: Chen Ding, Bietigheim-Bissingen (DE)

(73) Assignee: Valeo Schalter und Sensoren GmbH, Bietigheim-Bissingen (DE)

(21) Appl. No.: 19/129,982

(22) PCT Filed: Nov. 9, 2023
(86) PCT No.: PCT/EP2023/081241

§ 371 Date: May 14, 2025

(30) Foreign Application Priority Data
Nov. 15, 2022 (DE) 10 2022 130 164.8

(51) Int. Cl. B60W 40/08; B60W 30/09; B60W 50/00; B60W 50/14

(52) U.S. Cl. CPC B60W 40/08; B60W 30/09; B60W 50/14; B60W 2050/0014; B60W 2050/0088; B60W 2540/12; B60W 2540/18; B60W 2540/229

(57) ABSTRACT

The invention relates to a method for operating a driver assistance system (12) for a motor vehicle (10), wherein a predetermined safety measure for the motor vehicle (10) is triggered by the driver assistance system (12) when a predetermined warning threshold value is reached during a journey of the motor vehicle (10). According to the invention, a first triggering event is detected, wherein the first triggering event comprises a first triggering of the predetermined safety measure within a first journey portion of the journey. A reaction and/or a reaction speed of a driver of the motor vehicle (10) to the first triggering event is then observed. An attention value of the driver is then adjusted depending on the observed reaction and/or the observed reaction speed. Finally, the warning threshold is adjusted depending on the adjusted attention value.

The invention relates to a method for operating a driver assistance system for a motor vehicle, wherein a predetermined security measure for the motor vehicle is triggered by the driver assistance system upon reaching a predetermined warning threshold value in the course of a journey of the motor vehicle. The invention additionally relates to such a driver assistance system and a motor vehicle having such a driver assistance system.

It is known that a deficient or decreasing level of attentiveness of a driver of a motor vehicle in road traffic can have the result that incidents are increasingly caused, for example, collisions. Many motor vehicles are therefore equipped with driver assistance systems, which can independently intervene in a current driving operation of the motor vehicle, for example, to independently trigger braking of the motor vehicle in case of deficient attentiveness of the driver (AEB—autonomous emergency braking). A corresponding collision warning is usually output by the driver assistance system before such automatically triggered braking of the motor vehicle (FCW—forward collision warning). Threshold values or warning threshold values can be specified for triggering the braking and/or the preceding warning, wherein the corresponding measure is triggered if the associated warning threshold value is exceeded. Such a warning threshold value can describe a remaining time, for example, in seconds, until the upcoming collision (TTC—time to collision). A corresponding warning threshold value can be referred to as the TTC threshold value.

Adapting a TTC threshold value to a currently driven speed of a motor vehicle and/or to a current relative speed of the motor vehicle in relation to a potential collision obstacle is known from DE 10 2015 117 976 A1. For this purpose, the respective currently driven speed of the motor vehicle and other road users have to be detected and processed in a complex manner.

Adapting a TTC threshold value depending on current ambient conditions, for example, a road inclination and/or an icy road, is known from CN 11 20 46 454 A. In other words, the warning threshold value can be adjusted upward here if a steep road and/or a slippery road surface results in an increased or extended braking distance. To implement the described method, current data about the road layout, the road status, and/or current weather conditions have to be retained and processed, which is also very complex.

Another known possibility for reducing the probability that an incident will be caused in road traffic due to deficient attentiveness of a driver of a motor vehicle is to continuously monitor the current attentiveness of the driver by means of sensors, for example, camera sensors, in the motor vehicle interior and to warn the driver accordingly if a decreased level of attentiveness is established (DMS—driver monitoring system). Automated or autonomous intervention of systems in a current driving operation of the vehicle thus does not take place here, but rather the driver is supposed to recover an increased level of attentiveness due to the warning. Such monitoring systems are disadvantageously complex to install, however, since they are dependent on a large number of sensors. These sensors detect and process a large amount of data, which makes the implementation of such systems in the motor vehicle context complex. In addition, such monitoring systems are unreliable. This is because if the light conditions in the motor vehicle interior are poor, for example, under certain circumstances the camera sensors cannot reliably detect the dwindling attentiveness of the driver.

Even if the driver is warned of his decreasing attentiveness by a DMS, he can ignore this warning and continue to participate in road traffic in spite of his deficient attentiveness. Driver observation systems thus only increase the general traffic safety to a limited extent.

One object of the present invention is to provide an efficient and reliable possibility for increasing the general traffic safety.

The object is achieved by the subjects of the independent claims. Advantageous refinements of the invention are described by the dependent claims, the following description, and the figures.

The invention is based on the finding that the scope and/or the frequency of the above-described intervention of driver assistance functions, for example, triggering an FCW or an AEB, in the course of a journey of a motor vehicle permits an inference about a current attentiveness of a driver of the motor vehicle.

A method for operating a driver assistance system for a motor vehicle is provided by the invention, wherein a predetermined safety measure for the motor vehicle is triggered by the driver assistance system upon reaching a predetermined warning threshold value in the course of a journey of the motor vehicle. The warning threshold value can be the above-described TTC warning threshold value. The predetermined safety measure can be, for example, the output of a collision warning and/or the intervention of an autonomous braking function of the motor vehicle. If the warning threshold value is preset to 3 seconds, for example, triggering of the safety measure takes place as soon it is recognized by the driver assistance system that a collision of the motor vehicle with an external object is to be expected in 3 seconds without the safety measure being taken. A typical warning threshold value for the intervention of an autonomous braking function can be 1.3 seconds.

According to the invention, such triggering is detected as a triggering event, wherein a first triggering event comprises a first triggering of the predetermined safety measure within a first journey section of the journey. In addition, a reaction and/or a reaction speed of a driver of the motor vehicle to the first triggering event is observed. For example, it can be recognized by a brake pedal sensor of the motor vehicle when the driver carries out a braking procedure of the motor vehicle in reaction to the output collision warning. It may not only be detected in this case whether such a reaction takes place at all, but also at which time. In other words, it can be detected whether the driver reacts with a braking operation immediately after triggering of the collision warning, or only when the motor vehicle is already being autonomously braked.

According to the invention, an attentiveness value of the driver is adjusted depending on the observed reaction and/or the observed reaction speed. If no reaction is observed to the triggering of the safety measure, for example, the attentiveness value can thus be set from an initial value of 1 to 0. If a reaction is recognized immediately after triggering of a collision warning, the attentiveness value can be reduced to a value greater than zero, for example, 0.8. If a reaction does not take place to the triggering of the collision warning, but rather only in the course of an automatic braking procedure following the warning, the attentiveness value can be set to 0.4. If the driver thus does not brake immediately, but rather only when the autonomous braking system is already used or triggered, the attentiveness value is reduced more strongly than if the driver has already reacted to the collision warning with a braking procedure. The values mentioned here are solely by way of example and are not to be understood as restrictive.

According to the invention, the warning threshold value is adjusted depending on the adjusted attentiveness value. The warning threshold value can thus be increased in the case of a reduced attentiveness value, so that the predetermined safety measure for the motor vehicle is triggered far enough in the preparation for the recognized upcoming collision that more time remains to the inattentive driver for reaction.

The advantage results due to the method according to the invention that existing vehicle functions are used to determine the attentiveness value of the driver. This results in particularly efficient attentiveness monitoring. At the same time, the determination of the attentiveness value according to the invention is particularly reliable. Accordingly, the warning threshold value can also be adjusted very reliably. The invention thus advantageously enhances the general traffic safety.

The invention also includes embodiments which result in additional advantages.

One embodiment provides that if, in a further course of the journey during further subsequent journey sections, at least one further triggering event is detected, the reaction and/or the reaction speed of the driver to the at least one further triggering event is observed and the adjusted attentiveness value of the driver is updated on the basis of the observed reaction and/or the observed reaction speed to the at least one further triggering event, and wherein the adjusted warning threshold value is adjusted again as a function of the updated attentiveness value. In other words, according to the embodiment described here, the warning threshold value is dynamically adjusted to a changing attentiveness value in the further course of the journey. In other words, the reactions of the driver to multiple successive triggering events can be accumulated, wherein a progressively updated attentiveness value of the driver is determined from the accumulated reactions. For example, multiple successive triggering events and the reactions and/or reaction speeds of the driver observed thereupon can be accumulated until a critical limiting value is reached. Upon reaching the limiting value, the warning threshold value can be increased according to a defined increment or according to a defined step, for example, by one second.

The embodiment described here can be based on the situation that the attentiveness value of the driver at the beginning of the journey of the motor vehicle is at 100%. If a first triggering event takes place, for example, after a journey duration of 70 minutes, so that, for example, a warning about an upcoming collision is triggered, and the driver reacts with a braking operation to this warning, so that automatic braking is not caused by the motor vehicle, 5% can thus be subtracted from the attentiveness value, which is initially 100%. The attentiveness value after 70 minutes of the journey is thus at 95%.

In the further course of the journey, for example, after 75 minutes, a further triggering event can occur. In this case, a collision warning can again initially be output, wherein the driver does not brake in a timely manner during the further triggering event. Therefore, the autonomous braking system of the motor vehicle intervenes. If the driver only brakes with a delay, for example, while the autonomous braking system is still braking, 15% is thus subtracted from the attentiveness value. In this example, the attentiveness value is thus 80% after 75 minutes of driving time.

In the further course of the journey, for example, after 80 minutes, a third triggering event can occur. During this triggering event, for example, the driver no longer reacts at all. In other words, initially a collision warning is output, which is followed by an autonomous braking procedure of the motor vehicle. A reaction of the driver is not observed to the collision warning or in the course of the automatic braking procedure. In this example, 20% can be subtracted from the attentiveness value. The attentiveness value is therefore only still 60% after 80 minutes of the journey.

For example, a first limiting value for the attentiveness value is at 75%. In accordance with exceeding this first limiting value, one second can be added to the warning threshold value. A distinction can be made here between the warning threshold value for the triggering of the collision warning and the warning threshold value of the automatically performed braking procedure. Due to the increased warning threshold values, for example, the collision warning can already be triggered as a predetermined safety measure when an upcoming collision will not take place in 10 seconds, but rather in 11 seconds. At the same time, it can be defined for the triggering of the automatic braking procedure as a safety measure that it already begins in the case of an upcoming collision in five and a half seconds and not only in the case of an upcoming collision in five seconds. These examples illustrate that the predetermined safety measure for the motor vehicle is already triggered earlier with increased warning threshold value, so that the driver of the motor vehicle has more time for a reaction. The dynamic adjustment of the warning threshold value in the course of the journey in this manner has the advantage that it is possible to react flexibly to a respective current attentiveness or a current attentiveness value of the driver.

A further embodiment provides that the time interval between successive triggering events in the course of the journey and/or the frequency of the triggering events in the course of the journey is taken into consideration in the adjustment of the attentiveness value and/or the warning threshold value. If, for example, particularly many triggering events take place in a short time, for example, more than 10 triggering events in less than 10 minutes, an additional factor can be taken into consideration in the reduction of the attentiveness value and/or in the increase of the warning threshold value.

A further embodiment provides that at a predetermined point in time after passage of a predetermined journey duration of the journey, the attentiveness value of the driver is updated in that the triggering event lying farthest back from the point in time and the reaction and/or reaction speed of the driver observed thereto are discarded, wherein the warning threshold value is adjusted again as a function of the updated attentiveness value at the point in time. In other words, the triggering event lying farthest back is no longer considered in the adjustment of the warning threshold value. In other words, a driver can improve his attentiveness value again in the course of the journey.

For the above-described example, this may mean that, for example, after a journey time of 100 minutes, the initially subtracted 5% is added to the attentiveness value again. The attentiveness value after 100 minutes is accordingly at 65% again.

The triggering events are preferably finally discarded upon ending the current journey. In other words, the driver can start again with the original attentiveness value of 100% upon the next journey. The advantage results in this way that when the attentiveness of the driver is increased again, an unnecessarily long prewarning duration is not selected.

A further embodiment provides that the predetermined safety measure comprises successive individual measures, wherein the individual measures are classified on the basis of predetermined measure classes. In the embodiment described here, the adjustment of the attentiveness value and/or the warning threshold value takes place depending on during the course of which of the successive individual measures the reaction of the driver takes place. In order to remain in the above-described example, the reaction of the driver can already take place, for example, during the output of the collision warning. This results in a lower reduction of the attentiveness value than if the driver first intervenes in the course of the subsequent autonomous braking operation of the motor vehicle. In this way, an enhanced granularity in the adjustment of the attentiveness value and therefore also in the adjustment of the warning threshold value advantageously results.

A further embodiment provides that the predetermined safety measure comprises the output of a warning, in particular a collision warning about an upcoming collision, to the driver of the motor vehicle and/or a following intervention of at least one autonomous safety system, for example, an autonomous braking system of the motor vehicle. In other words, the safety measure preferably comprises the intervention of an autonomous safety system of the motor vehicle, in particular an autonomous performance of a braking procedure.

The reaction of the driver preferably comprises a steering intervention and/or a braking procedure.

A further embodiment provides that data are acquired from a driver monitoring system (DMS) and additionally considered for adjusting the attentiveness value of the driver and/or for adjusting the warning threshold value. In other words, the DMS can determine its own attentiveness value, for example, on the basis of camera monitoring of the driver. The attentiveness values from the DMS and from the driver assistance system described here can be offset to form a common attentiveness value. It can preferably be provided that the DMS attentiveness value is classified as less credible than the attentiveness value which results from the observation of the driver reactions according to the invention. In other words, the DMS attentiveness value can be overwritten. The advantage results in this way that the technical requirements for the DMS decrease. It thus does not have to be equipped with a large number of sensors in a complex manner.

The invention additionally relates to a driver assistance system for a motor vehicle, wherein the driver assistance system is designed to carry out the described method. The driver assistance system comprises a sensor device or a sensor system having multiple sensors and a controller to carry out the method according to the invention. The driver assistance system can comprise or actuate environmental sensors or an environmental sensor system, in particular the multiple sensors of the sensor system, to acquire environmental data of the motor vehicle. An environmental sensor system can be understood, for example, as a sensor system which is capable of generating sensor data or sensor signals that depict, represent, or reflect an environment of the environmental sensor system. In particular, the capability of acquiring electromagnetic or other signals from the environment is not sufficient to consider a sensor system an environmental sensor system. For example, cameras, radar systems, lidar systems, or ultrasonic sensor systems can be interpreted as environmental sensor systems.

The sensor system can comprise, for example, sensors, using which an upcoming collision and/or a time until this collision can be detected. These sensors can in particular be cameras, radar systems, lidar systems, or ultrasonic sensor systems.

In addition, the sensor system can comprise sensors, using which a movement of the motor vehicle can be detected, or sensors which can detect variables relating to a movement of the motor vehicle. These sensors can include, for example, an IMU (inertial measurement unit), which measures accelerations of the motor vehicle in one or more directions and/or rotation rates, for example, a yaw rate. These sensors can also include wheel sensors, which measure revolutions of the wheels of the motor vehicle, based on which the velocity of the motor vehicle can be calculated. In addition, these sensors can also comprise a steering wheel/steering column sensor, which measures the angle and/or the angular velocity of the steering wheel or a steering wheel revolution or partial revolution.

In addition, the driver assistance system can comprise an electronic controller, by means of which the triggering events and/or the corresponding reactions or reaction speeds of the driver of the motor vehicle to the triggering events can be recorded or detected. A steering system, a drive motor, and/or a braking system of the motor vehicle can also be actuated by means of the controller.

The invention additionally relates to a computer program comprising commands which, upon execution by the driver assistance system according to the invention, cause the driver assistance system according to the invention to carry out the method steps of the method according to the invention.

The invention additionally relates to a computer-readable storage medium, on which the computer program is stored.

The invention additionally relates to a motor vehicle having a driver assistance system according to the invention. The motor vehicle is preferably designed as a passenger vehicle, a truck, a bus, a motorcycle, or a moped.

The preferred embodiments introduced with respect to the method according to the invention, and the advantages thereof, correspondingly apply to the driver assistance system according to the invention and to the motor vehicle according to the invention and vice versa.

Further features of the invention can be found in the claims, the figures, and the description of the figures. The features and combinations of features mentioned above in the description and the features and combinations of features mentioned below in the description of the figures and/or shown on their own in the figures may be used not only in the respectively indicated combination but also in other combinations without departing from the scope of the invention. Embodiments of the invention that are not explicitly shown and explained in the figures but emerge and are producible from the explained embodiments by separate combinations of features, should therefore also be regarded as included and disclosed. Embodiments and combinations of features that thus do not have all the features of an originally formulated independent claim should also be regarded as disclosed. Furthermore, embodiments and combinations of features that go beyond or deviate from the combinations of features outlined in the back-references of the claims should be regarded as disclosed, in particular by the embodiments outlined above.

Exemplary embodiments of the invention are described hereinafter. In the figures:

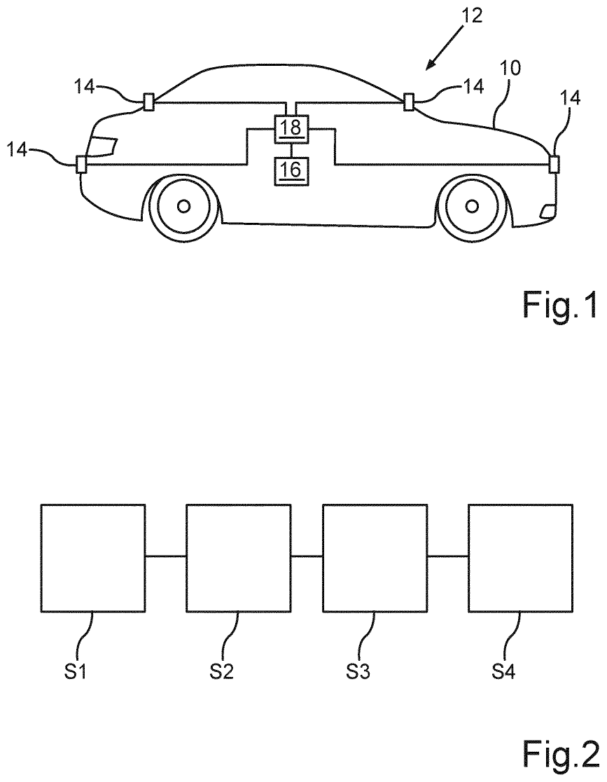

FIG. 1 shows a motor vehicle having a driver assistance system;

FIG. 2 shows a schematic representation of a method according to an embodiment of the invention.

The exemplary embodiments explained hereinafter are preferred embodiments of the invention. In the exemplary embodiments, the described components of the embodiments each represent individual features of the invention to be considered independently of one another, which each also refine the invention independently of one another and therefore are also to be viewed as parts of the invention individually or in a combination other than that shown. Furthermore, the described embodiments can also be supplemented by further features of the invention already described.

In the figures, identical reference signs each identify functionally identical elements.

FIG. 1 shows a schematic view of a motor vehicle 10 comprising a driver assistance system 12. The motor vehicle 10 is designed in the embodiment shown as a passenger vehicle. The motor vehicle 10 comprises multiple sensors 14 of a sensor device (not described in more detail). These sensors 14 include camera sensors and/or distance sensors by way of example according to the exemplary embodiment described here, which can be arranged in different areas of the motor vehicle 10. In addition, the sensor device comprises one or more sensors 16 which can be designed, for example, to detect a movement of the motor vehicle 10 or to detect variables which relate to or influence a movement of the motor vehicle 10. A steering angle and/or a revolution of at least one wheel of the motor vehicle 10 can be determined using the sensor 16, for example. The sensor 16 can be designed to detect a current velocity and/or one or more accelerations and/or rotation rates of the motor vehicle 10. This can also include detecting a braking procedure, in particular an autonomously performed braking procedure. The motor vehicle 10 can additionally comprise further sensors 14, for example, a brake pedal sensor and/or camera sensors for driver monitoring in the motor vehicle interior.

The sensors 14, 16 can be connected to a controller 18 of the driver assistance system 12 for data transmission.

FIG. 2 shows, with reference to the components denoted and described in conjunction with FIG. 1, a schematic representation of a method for operating a driver assistance system 12 for a motor vehicle 10. In the method, a predetermined safety measure for the motor vehicle 10 is triggered by the driver assistance system 12 upon reaching a predetermined warning threshold value in the course of a journey of the motor vehicle 10.

In a step S1, a first triggering event is detected, wherein the first triggering event comprises a first triggering of the predetermined safety measure within a first journey section of the journey. In a step S2, a reaction and/or a reaction speed of a driver of the motor vehicle 10 to the first triggering event is observed. In a step S3, an attentiveness value of the driver is adjusted or updated depending on the observed reaction and/or the observed reaction speed. Finally, in a step S4, the warning threshold value is adjusted or updated depending on the adjusted attentiveness value.

One preferred embodiment of the present invention provides dynamically adjusting warning threshold values in the course of a journey of the motor vehicle 10. The adjustment can take place here depending on a scope and/or a frequency of observed triggering events during the journey or during a predetermined journey section.

For example, the driver assistance system 12 stores the described triggering events during a preceding time span or a preceding journey section and assesses an attentiveness of the driver on the basis of the triggering events. A triggering event can be described here by a time stamp, by the type of the triggered safety measure, and/or by the driver reaction.

At the beginning of the journey, for example, upon starting of a vehicle motor, the attentiveness value of the driver can be 100%. The warning threshold values for different safety measures can be preset at the beginning of the journey. The preset can be determined, for example, by a factory setting or also by a driver selection. If a first safety measure is now triggered, for example, the output of a warning in reference to an upcoming collision, and at the same time a braking procedure and/or steering procedure of the driver is detected, so that no automatic braking procedure is triggered, a small fraction is thus subtracted from the current attentiveness value of the driver. If the braking procedure or steering procedure of the driver is not sufficient to prevent an intervention of the automatic braking function, a larger fraction is thus subtracted from the current attentiveness value. If the driver brakes and/or the driver steers while the automatic braking function has intervened, an even larger fraction is thus subtracted from the current attentiveness value. If no reaction of the driver takes place or a reaction only takes place after the motor vehicle has autonomously stopped, an even larger fraction is thus subtracted from the attentiveness value. If the attentiveness value should fall below a predetermined limiting value, for example, below 50% of the starting value, the warning threshold values for the different safety measures can thus be increased. There can be different limiting values here. For example, a further limiting value can be at 25% of the starting value of 100%. The warning threshold values are preferably raised all the more the lower a respective achieved limiting value is.

If one of the recorded triggering events lies farther back than a predetermined period of time, the contribution of this triggering event can be discarded or dropped in the adjustment of the attentiveness value. This means that the fraction which was subtracted from the attentiveness value in dependence on this triggering event can be added again. The triggering events can be erased or overwritten by newly recorded triggering events. This mechanism can prevent deductions from the attentiveness value from accumulating during an indeterminate time. It is thus possible to prevent the attentiveness value of the driver from constantly decreasing, which can result in unnecessarily elevated warning threshold values and/or safety measures triggered unnecessarily early.

The described solution can function alone if the motor vehicle 10 is not equipped with an additional driver monitoring system or the like for assessing a driver attentiveness. Alternatively, the proposed solution can also function jointly with an existing driver observation system or similar mechanisms. If, for example, a DMS should report an increased driver attentiveness, the attentiveness value described here can thus also be increased. If one or more triggering events should be detected, the DMS can thus also reduce its driver attentiveness value.

The invention provides a simple, reliable, and effective solution for adjusting warning threshold values as needed. Driver assistance functions already existing in the motor vehicle or functions of an ADAS (ADAS-automated driver assistance system) can be used for this purpose.

1. A method for operating a driver assistance system for a motor vehicle, wherein the driver assistance system comprises a sensor system having multiple sensors and a controller, wherein a predetermined safety measure for the motor vehicle is triggered by the driver assistance system if a predetermined warning threshold value is reached in the course of a journey of the motor vehicle, the method comprising:
detecting a first triggering event by means of at least one sensor of the sensor system, wherein the first triggering event comprises a first triggering of the predetermined safety measure within a first journey section of the journey,
observing a reaction and/or a reaction speed of a driver of the motor vehicle to the first triggering event by means of at least one further sensor of the sensor system,
adjusting an attentiveness value of the driver depending on the observed reaction and/or the observed reaction speed by way of the controller,
adjusting the warning threshold value in dependence on the adjusted attentiveness value by way of the controller.

2. The method as claimed in claim 1, wherein, if at least one further triggering event is detected in a further course of the journey during further following journey sections, the reaction and/or the reaction speed of the driver to the at least one further triggering event is observed and the adjusted attentiveness value of the driver is updated on the basis of the observed reaction and/or the observed reaction speed to the at least one further triggering event, and wherein the adjusted warning threshold value is adjusted again depending on the updated attentiveness value.

3. The method as claimed in claim 2, wherein the time interval between successive triggering events in the course of the journey and/or the frequency of the triggering events in the course of the journey is taken into consideration in the adjustment of the attentiveness value and/or the warning threshold value.

4. The method as claimed in claim 1, wherein the attentiveness value of the driver is updated at a predetermined point in time after passage of a predetermined journey duration of the journey, in that the triggering event lying farthest back at the point in time and the reaction and/or the reaction speed of the driver observed thereto are discarded, wherein the warning threshold value is adjusted, in particular again, depending on the updated attentiveness value at the point in time.

5. The method as claimed in claim 1, wherein the predetermined safety measure comprises successive individual measures, wherein the individual measures are classified on the basis of predetermined measure classes, and wherein the adjustment of the attentiveness value and/or the warning threshold value takes place depending on during the course of which of the successive individual measures the reaction of the driver takes place.

6. The method as claimed in claim 1, wherein the predetermined safety measure comprises the output of a collision warning, in about an upcoming collision of the motor vehicle with a motor vehicle-external object, to the driver of the motor vehicle and/or an intervention of at least one autonomous safety system of the motor vehicle in a current operation of the motor vehicle.

7. The method as claimed in claim 6, wherein the intervention of the at least one autonomous safety system of the motor vehicle comprises an autonomous performance of a braking procedure.

8. The method as claimed in claim 1, wherein the reaction of the driver comprises a steering intervention and/or a braking procedure.

9. The method as claimed in claim 1, wherein data are acquired from a driver monitoring system, and wherein the data are additionally taken into consideration for the adjustment of the attentiveness value of the driver and/or for the adjustment of the warning threshold value.

10. A driver assistance system, comprising:
a sensor system having multiple sensors; and
a controller, wherein the driver assistance system is configured to trigger a predetermined safety measure for the motor vehicle if a predetermined warning threshold value is reached in the course of a journey of the motor vehicle,
wherein
at least one sensor of the sensor system is configured to detect a first triggering event, wherein the first triggering event comprises a first triggering of the predetermined safety measure within a first journey section of the journey,
at least one further sensor of the sensor system is configured to observe a reaction and/or a reaction speed of a driver of the motor vehicle to the first triggering event,
the control unit is configured to adjust an attentiveness value of the driver depending on the observed reaction and/or the observed reaction speed, and wherein
the control unit is configured to adjust the warning threshold value depending on the adjusted attentiveness value.

11. A motor vehicle having a driver assistance system as claimed in claim 10.

12. (canceled)

13. A non-transitory computer-readable storage medium comprising instructions, which upon execution by a driver assistance system, cause the driver assistance system to perform a method as claimed in claim 1.
